(19) United States
(12) Patent Application Publication
(10) Pub. No.: US 2020/0341145 A1
(43) Pub. Date: Oct. 29, 2020

(54) LIGHT DETECTOR

(71) Applicant: Shenzhen Genorivision Technology Co. Ltd., Shenzhen (CN)

(72) Inventors: Peiyan CAO, Shenzhen (CN); Yurun LIU, Shenzhen (CN)

(21) Appl. No.: 16/924,342

(22) Filed: Jul. 9, 2020

Related U.S. Application Data
(63) Continuation of application No. PCT/CN2018/075182, filed on Feb. 3, 2018.

(51) Int. Cl. G01S 17/10; G01S 7/481

(52) U.S. Cl. CPC G01S 17/10; G01S 7/4814; G01S 7/4817

(57) ABSTRACT

Disclosed herein is an apparatus, comprising a light source configured to generate light pulses, wherein one or more attributes of the light pulses are modulated according to a first code, the one or more attributes of the light pulses selected from a group consisting of amplitudes of the light pulses, time intervals between the light pulses, widths of the light pulses, spectra of the light pulses, and a combination thereof; a detector configured to receive a mixture of light comprising respective portions of the light pulses scattered by a portion of a target scene, configured to select the portions of the light pulses from the mixture of light based on a second code, and configured to generate electric signals based on a characteristic of the portions of the light pulses.

### TECHNICAL FIELD

The disclosure herein relates to light detectors, particularly relates to a light detector with signal modulations.

### BACKGROUND

Lidar is a laser-based method of detection, range finding and mapping. There are several major components to a lidar system: laser source, scanner and optics, photo detectors and receiver electronics. For example, controlled steering of scanning laser beams is carried out, and by processing the captured return signals reflected from distant objects, buildings and landscapes, distances and shapes of these objects, buildings and landscapes may be obtained.

Lidar system is widely used. For example, autonomous vehicles (e.g., driverless cars) use lidar (also known as on-vehicle lidar) for obstacle detection and collision avoidance to navigate safely through environments. An on-vehicle lidar is mounted on the roof of a driverless car and it rotates constantly to monitor the current environment around the car. The lidar sensor provides the necessary data for software to determine where potential obstacles exist in the environment, help identify the spatial structure of the obstacle, distinguish objects based on size and estimate the impact of driving over it. One advantage of the lidar systems compared to radar systems is that the lidar systems can provide better range and a large field of view, which helps detecting obstacles on the curves. Despite tremendous progress has been made in developing lidar systems in recent years, a lot of efforts are still being made these days to design lidar systems for various application needs, including developing new light sources that can perform controlled scanning, and developing new detectors that can modulate light pulse signals to resolve interference from different light sources.

### SUMMARY

Disclosed herein is an apparatus, comprising a light source configured to generate light pulses, wherein one or more attributes of the light pulses are modulated according to a first code, the one or more attributes of the light pulses selected from a group consisting of amplitudes of the light pulses, time intervals between the light pulses, widths of the light pulses, spectra of the light pulses, and a combination thereof; a detector configured to receive a mixture of light comprising respective portions of the light pulses scattered by a portion of a target scene, configured to select the portions of the light pulses from the mixture of light based on a second code, and configured to generate electric signals based on a characteristic of the portions of the light pulses.

According to an embodiment, the light source is configured to change its total radiant flux as a function of time, based on the first code.

According to an embodiment, the light source is configured to change its spectral flux as a function of time, based on the first code.

According to an embodiment, the light source is configured to vary a proportion of its total radiant flux in the light pulses as a function of time, based on the first code.

According to an embodiment, the light source comprises a shutter and is configured to vary the proportion using the shutter.

According to an embodiment, the light source comprises one or more optical filters and is configured to vary the proportion using the one or more optical filters.

According to an embodiment, the detector is configured to select the portions of the light pulses by correlating the mixture of light with the second code.

According to an embodiment, the characteristic is time-of-flight.

According to an embodiment, the light source comprises a light emitter and a light scanner, wherein the light scanner is configured to receive light from the light emitter and affect a direction of the light with respect to the target scene.

According to an embodiment, the light scanner comprises optical waveguides and an electronic control system; the optical waveguides are configured to receive light from the light emitter; the electronic control system configured to adjust dimensions of the optical waveguides by regulating temperatures of the optical waveguides.

According to an embodiment, regulating the temperatures of the optical waveguides comprises applying an electric current through the optical waveguides.

According to an embodiment, at least one of the optical waveguides comprises a conductive cladding around a core.

According to an embodiment, applying the electric current through the optical waveguides comprises applying the electric current through the conductive cladding.

According to an embodiment, the optical waveguides are formed on a surface of a substrate.

According to an embodiment, at least one of the optical waveguides is curved.

### BRIEF DESCRIPTION OF FIGURES

FIG. 1 schematically shows a perspective view of an apparatus suitable for light emission, light modulation and detection, according to an embodiment.

FIG. 2 schematically shows a functional block diagram of a light source, according to one embodiment.

FIG. 3 and FIG. 4 each schematically show a functional block diagram of an alternative light source, according to one embodiment.

FIG. 5 schematically shows a cross-sectional view of the detector, with light receiving components and signal processors, according to one embodiment.

FIG. 6 schematically shows a functional block diagram of the detector, according to an embodiment.

FIG. 7A schematically shows a perspective view of a light steering component, according to one embodiment.

FIG. 7B schematically shows a cross-sectional view of the light steering component, according to one embodiment.

FIG. 7C schematically shows a cross-sectional view of the light steering component, according to another embodiment.

FIG. 7D schematically shows a cross-sectional view of the light steering component, according to an embodiment.

### DETAILED DESCRIPTION

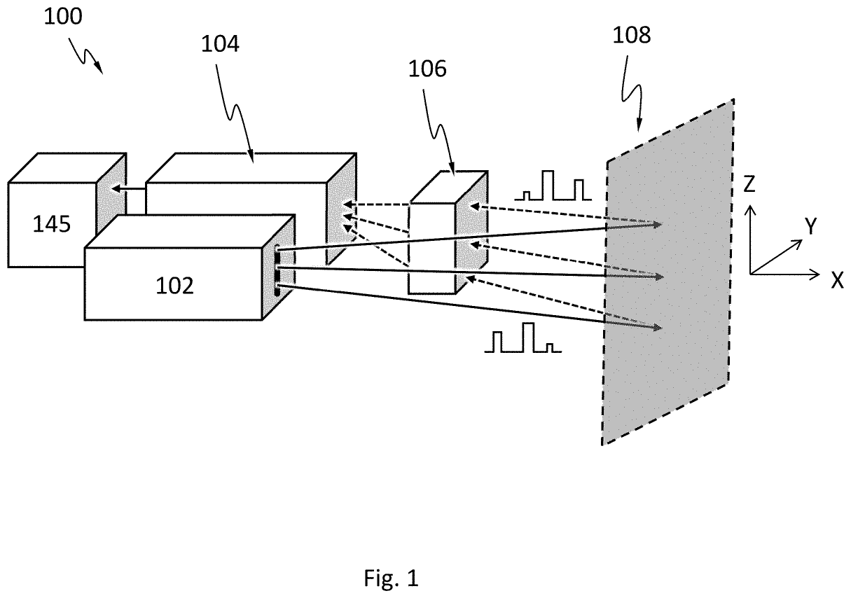

FIG. 1 schematically shows an apparatus 100 suitable for light emission, modulation and detection, according to an embodiment. The apparatus 100 may comprise a light source 102, a detector 104 and an optical device 106. The light source 102 may be configured to generate light pulses to illuminate a portion of a target scene 108. The portion of the target scene 108 may scatter the light pulses. One or more attributes of the light pulses may be modulated according to a first code. The one or more attributes may be amplitudes of the light pulses, time intervals between the light pulses, widths of the light pulses, spectra of the light pulses, or combinations thereof.

The optical device 106 may be configured to affect (e.g., converge) the light pulses scattered by the portion of the target scene 108. The optical device 106 may be positioned between the detector 104 and the target scene 108.

The detector 104 may be configured to receive a mixture of light that includes portions of the light pulses scattered by the target scene 108. The mixture of light may include light that does not originate from the light source 102. The detector 104 may be configured to select the portions of the light pulses from the mixture of light based on a second code. In one embodiment, the detector 104 may be configured to generate electrical signals based on a characteristic of the portions of the light pulses. An example of the characteristic is a time-of-flight of the light pulses from the light source 102 to the target scene 108 and back to the detector 104. The apparatus 100 may further comprise a signal processor 145 configured to process and analyze the electrical signals.

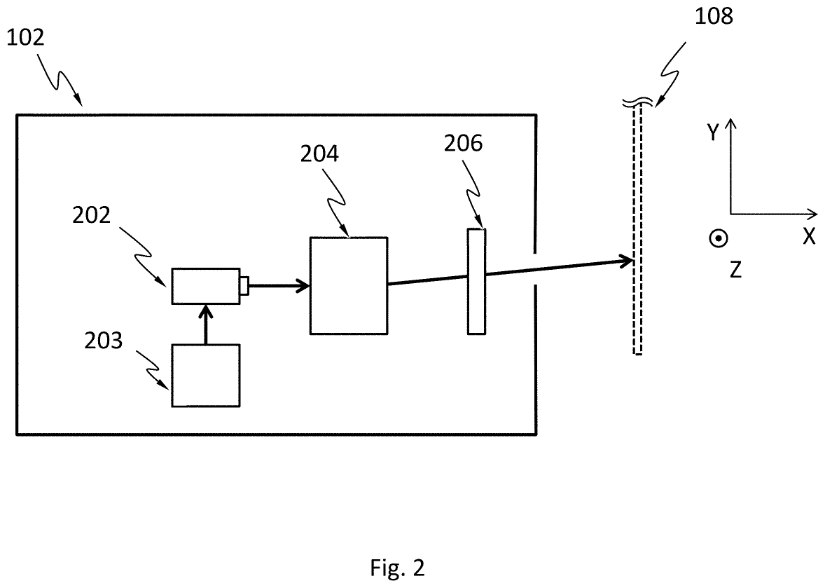

FIG. 2 schematically shows a functional block diagram of the light source 102, according to an embodiment. The light source 102 may be configured to generate the light pulses by changing its total radiant flux as a function of time (in contrast with changing the proportion of the total radiant flux included in the light pulses) based on the first code, or by its spectral flux as a function of time based on the first code. The light source 102 may comprise a light emitter 202. The light emitter 202 may be a laser source. As shown in FIG. 2, the light source 102 may use a controller 203 to change its total radiant flux (e.g., by varying the power supplied to the light emitter 202) or change its spectral flux, according to the first code. The first code may be a fixed code specific to the light source 102 or adjustable. The controller 203 may include TTL or other suitable analog circuits.

The light source 102 may include a light scanner 204. The light scanner 204 may be configured to receive light from the light emitter 202, to affect the direction of (e.g., scan) the light with respect to the target scene 108. For example, the light scanner 204 may scan the light in the Y dimension, as shown in FIG. 2. The light source 102 may include an optical component 206 configured to shape (e.g., diverge) the light from the light scanner 204. As shown in FIG. 2, the optical component 206 may be positioned between the light scanner 204 and the target scene 108. Alternatively, the light scanner 204 may be positioned between the optical component 206 and the target scene 108. In an embodiment, the optical component 206 may comprise a one-dimensional diffraction grating or a cylindrical lens.

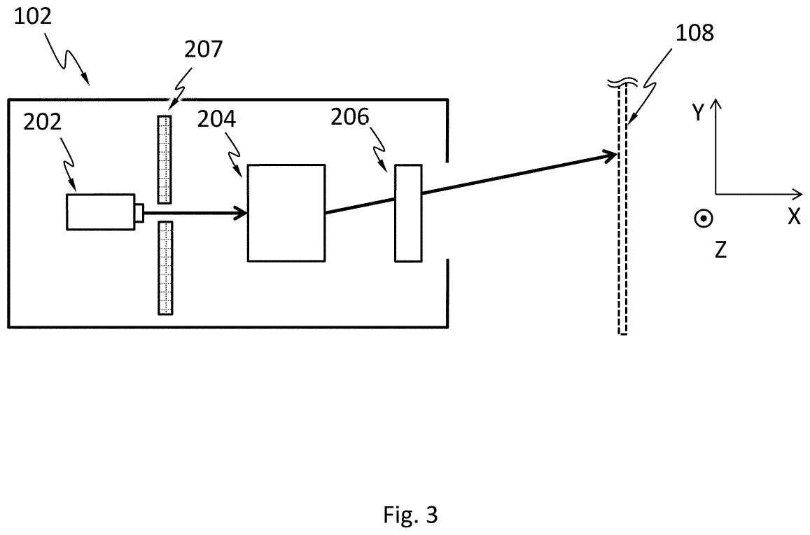

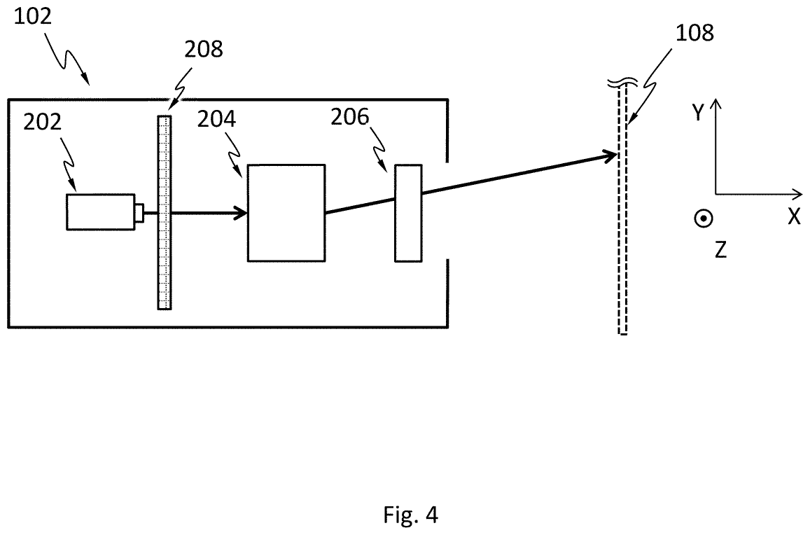

FIG. 3 and FIG. 4 each schematically show a functional block diagram of the light source 102, according to an embodiment. The light source 102 may be configured to generate the light pulses by varying a proportion of its total radiant flux in the light pulses as a function of time (in contrast with changing its total radiant flux), based on the first code. The light source 102 may comprise the light emitter 202. The light emitter 202 may be a laser source. The total radiant flux of the light emitter 202 may be constant. As shown in FIG. 3, the light source 102 may use a shutter 207 to vary the proportion of its total radiant flux in the light pulses, according to the first code. For example, the proportion may be varied by opening or closing the shutter 207 following a temporal sequence based on the first code. As shown in FIG. 4, the light source 102 may use one or more optical filters 208 to vary the proportion of its total radiant flux in the light pulses, according to the first code. For example, the proportion may be varied by changing the transmission spectrum of the one or more optical filters 208 following a temporal sequence based on the first code.

The light source 102 may comprise a light scanner 204. The light scanner 204 may be configured to receive light from the light emitter 202, to change the direction of (e.g., scan) the light with respect to the target scene 108. For example, the light scanner 204 may scan the light in the Y dimension, as shown in FIG. 3 and FIG. 4. The light source 102 may include an optical component 206 configured to shape (e.g., diverge) the light from the light scanner 204. As shown in FIG. 3 and FIG. 4, the shutter 207 or the one or more optical filters 208 may be positioned between the light scanner 204 and the light emitter 202. Alternatively, the shutter 207 or the one or more optical filters 208 may be positioned at another suitable place along the optical path. In an embodiment, the optical component 206 may comprise a one-dimensional diffraction grating or a cylindrical lens.

The light source 102 may be configured to generate the light pulse by changing its total radiant flux as a function of time and by varying a proportion of its total radiant flux in the light pulse as a function of time.

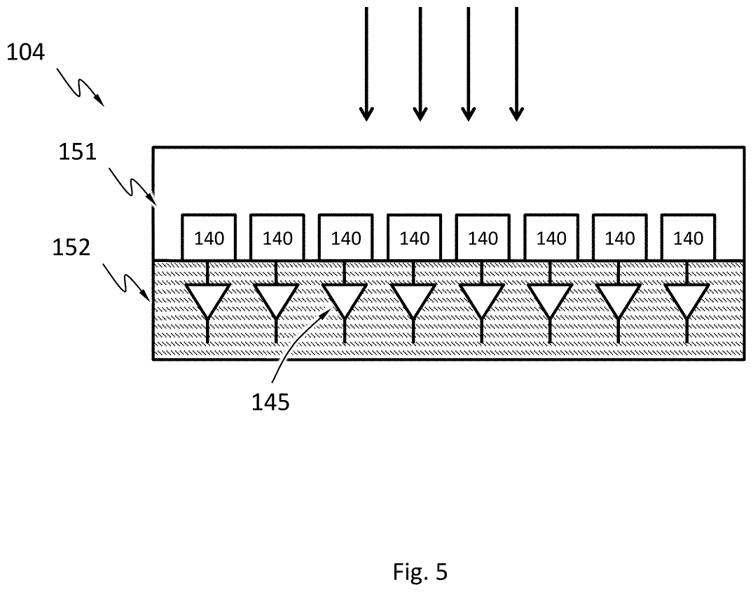

FIG. 5 schematically shows a cross-sectional view of the detector 104, according to an embodiment. The detector may comprise a light receiving layer 151 and an electronics layer 152. The light receiving layer 151 may stack up on top of the electronics layer 152. The plurality of light receiving components 140 are inside the light receiving layer 151, according to an embodiment. When the return light from the target scene 108 hits the detector 104, the light receiving components 140 may generate charge carriers. The charge carriers may be directed (e.g., under an electric field) to a signal processor 145 in the electronics layer 152.

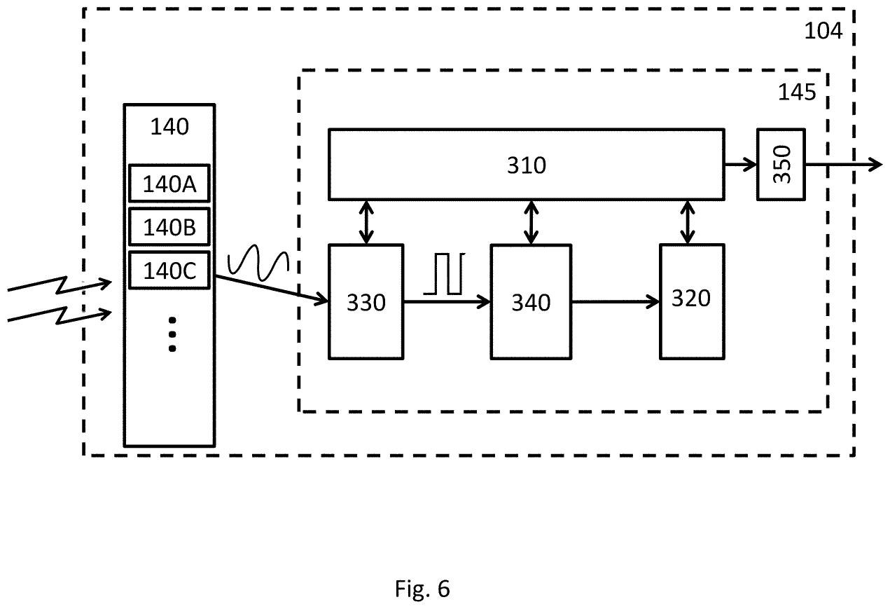

FIG. 6 schematically shows a functional block diagram of the detector 104, according to an embodiment. The mixture of light comprising a portion of the light pulse that is modulated according to the first code and scattered by the portion of the target scene may generate charge carriers in the light receiving component 140. In an embodiment, the light receiving component 140 may include sub-components configured to receive light of different spectral ranges (e.g., sub-component 140A configured to receive light from λ₁-λ₂, sub-component 140B configured to receive light from λ₃-λ₄, sub-component 140C configured to receive light from λ₅-λ₆, etc.) The charge carriers may be converted to electrical signals, and the electrical signals may be processed by the signal processor 145. The signal processor 145 may comprise an analog circuitry such as one or more Analog-to-Digital converters 330 configured to digitize the electrical signals. The detector 104 may select the portion of the light pulse from the mixture of light, for example, using the signal processor 145. The signal processor 145 may have a demodulator 340 configured to correlate the mixture of light (as represented by the electrical signals) with the second code with varying delays between the mixture of light (as represented by the electrical signals) and the second code. The portion of the light pulse may be selected based on the results of the correlation. In an example, the result of the correlation is non-trivial if and only if the delay between the portion of the light pulse and the second code is zero. A characteristic (e.g., time-of-light) of the portion of the light pulse may be determined by the detector 104 (e.g., by a microprocessor 310 in the signal processor 145) and stored in a memory or a counter 320. A communication interface 350 may be included in the signal processor 145, and the communication interface 350 may be configured to communicate with other circuitry outside the signal processor 145, or outside the detector 104.

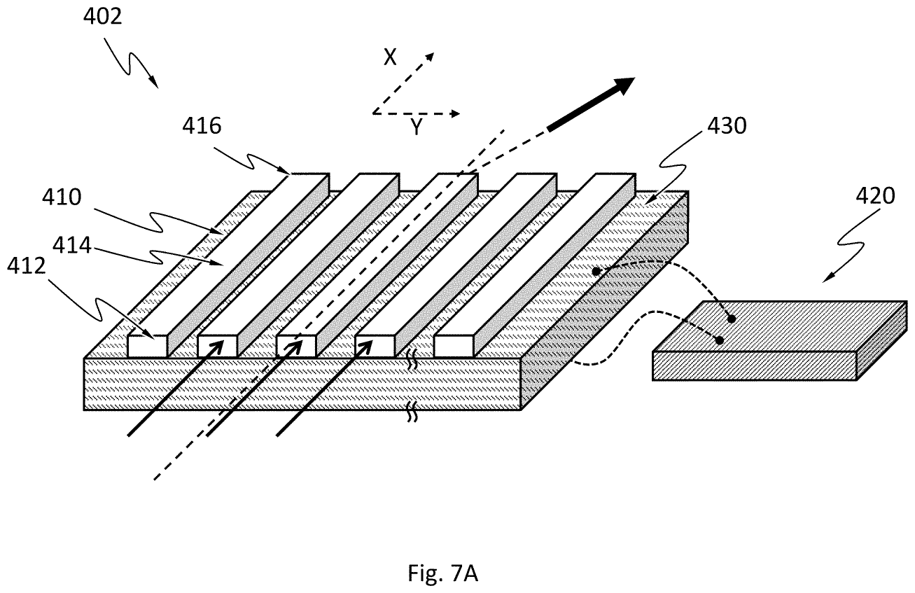

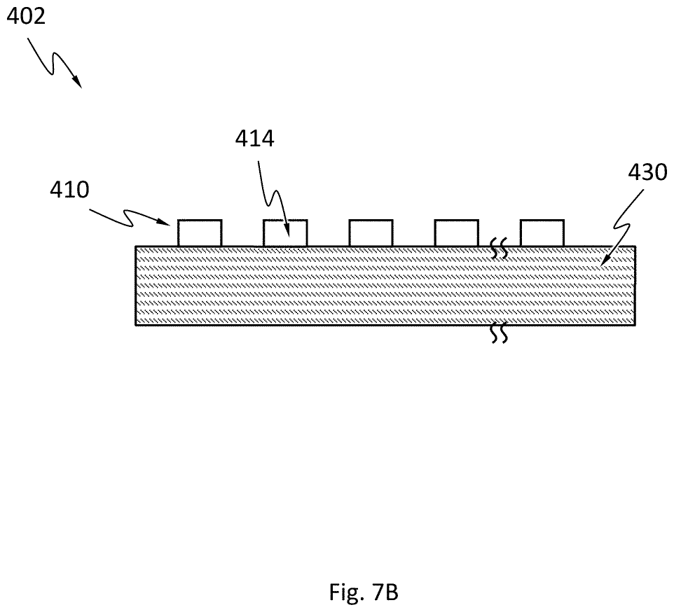

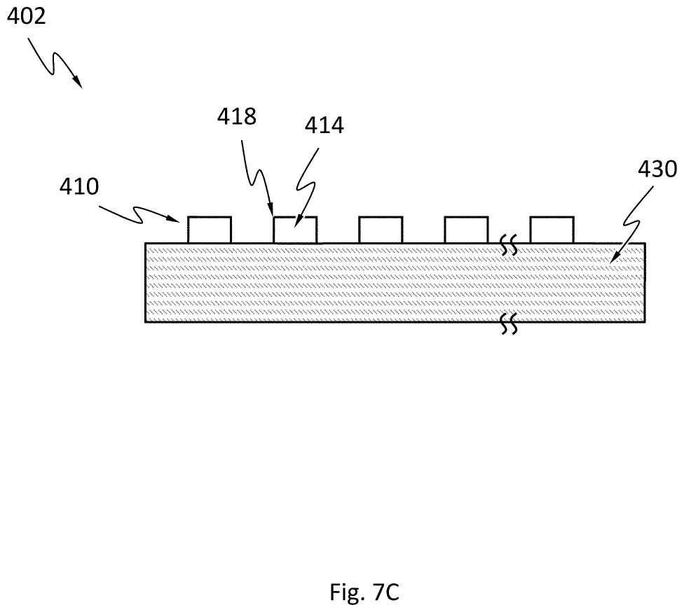

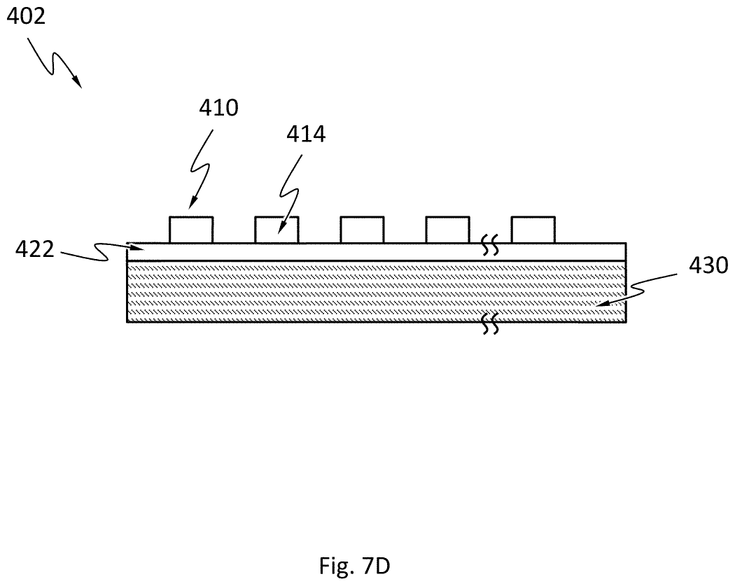

FIG. 7A schematically shows a perspective view of the light steering component 402, according to one embodiment. The light steering component 402 may be an embodiment of the light scanner 204 of the light source 102 and may comprise a plurality of optical waveguides 410 and an electronic control system 420. In one embodiment, the plurality of optical waveguides 410 may lie on a surface of a substrate 430. The plurality of optical waveguides 410 may be controlled by the electronic control system 420 to generate a scanning light beam and steer the scanning light beam in the second dimension.

Each of the optical waveguides 410 may comprise an input end 412, an optical core 414 and an output end 416. The optical core 414 may comprise an optical medium. In one embodiment, the optical medium may be transparent. The input ends 412 of the optical waveguides 410 may receive input light waves and the received light waves may pass through the optical cores 414 and exit as output light waves from the output ends 416 of the optical waveguides 410. Diffraction may cause the output light waves from each of the optical cores 414 to spread over a wide angle so that when the input light waves are coherent (e.g., from a coherent light source such as a laser), the output light waves from the plurality of optical waveguides 410 may interfere with each other and exhibit an interference pattern. In one embodiment, the output ends 416 of the plurality of optical waveguides 410 may be arranged to line up in the second dimension. For example, as shown in FIG. 7A, the output ends 416 of the plurality of optical waveguides 410 may be lined up in Y dimension. This way, the output interfaces may face the X direction.

The electronic control system 420 may be configured to control phases of the output light waves from the plurality of optical waveguides 410 for the interference pattern to generate a scanning light beam and steer the scanning light beam in the second dimension. Dimensions of each of the optical cores 414 may be individually adjusted by the electronic control system 420 to control phases of output light waves from respective optical cores 414. The electronic control system 420 may be configured to individually adjust the dimensions of each of the optical cores 414 by regulating the temperature of each of the optical cores 414 respectively.

In an embodiment, the light waves of the input light beam to the plurality of optical waveguides 410 may be at a same phase. The interference pattern of the output light waves from the plurality of optical waveguides 410 may comprise one or more propagating bright spots where output light waves constructively interfere (e.g., re-enforce) and one or more propagating weak spots where output light waves destructively interfere (e.g., cancel out each other). In an embodiment, the one or more propagating bright spots may form one or more scanning light beams. If the phases of the output light beams of the optical cores 414 shift and the phase differences change, the constructive interferences may happen at different directions so that the interference pattern of the output light waves (e.g., the directions of the one or more scanning light beams generated) may also change. In other words, light beam steering in the second dimension may be realized by adjusting the phases of the output light beams from the plurality of optical waveguides 410.

One way of adjusting the phases of the output light waves is changing the effective optical paths of the light waves propagated through the optical cores 414. An effective optical path of a light wave propagated through an optical medium may depend on the physical distance the light travels in the optical medium (e.g., depending on incident angle of the light wave, dimensions of the optical medium). As a result, the electronic control system 420 may adjust the dimensions of the optical cores 414 to change the effective optical paths of incident light beam propagates through the optical cores 414 so that the phases of the output light waves may shift under the control of the electronic control system 420. For example, the length of each of the optical cores 414 may change because at least a part of the respective optical cores 414 has a temperature change. Moreover, the diameter of at least a section of an optical core 414 may change if at least part of the section of the optical core 414 has a temperature change. Therefore, in one embodiment, regulating the temperature of each of the optical cores 414 may be used to control the dimensions of the optical cores 414 (e.g., due to the thermal expansion or contractions of the optical cores 414).

It should be noted that although FIG. 7A shows the plurality of optical waveguides 410 are arranged in parallel, this is not required in all embodiments. In some embodiments, the output ends 416 may be lined up in a dimension but the plurality of optical waveguides 410 need not be straight or be arranged in parallel. For example, in one embodiment, at least one of the optical waveguide 410 may be curved (e.g., “U” shaped, “S” shaped, etc.). The cross-sectional shape of the optical waveguides 410 may be a rectangle, circle, or any other suitable shape. In an embodiment, the plurality of optical waveguides 410 may form a one-dimensional array placed on a surface of the substrate 430 as shown in FIG. 7A. The optical waveguides 410 need not to be evenly distributed in the one-dimensional array. In other embodiments, the plurality of optical waveguides 410 needs not to be on one substrate. For example, some optical waveguides 410 may be on one substrate, some other optical waveguides 410 may be on a separate substrate.

The substrate 430 may include conductive, non-conductive or semiconductor materials. In an embodiment, the substrate 430 may include a material such as silicon dioxide. In an embodiment, the electronic control system 420 may be embedded in the substrate 430 but also may be placed outside of the substrate 430.

In an embodiment, the light source 102 may further comprise a beam expander (e.g., a group of lenses). The beam expander may expand the input light beam before the input light beam enters the plurality of optical waveguides 410. The expanded input light beam may be collimated. In an embodiment, the light source 102 may further comprise a one-dimensional diffraction grating (e.g., a cylindrical microlens array) configured to converge and couple the light waves of the input light beam into the plurality of optical waveguides 410.

FIG. 7B schematically shows a cross-sectional view of the light steering component 402 of FIG. 7A, according to one embodiment. Each of the optical cores 414 may comprise an optical medium that is conductive and transparent. The optical cores 414 may be electrically connected to the electronic control system 420. In an embodiment, the electronic control system 420 may be configured to individually adjust the dimensions of each of the optical cores 414 by individually regulating the temperature of each of the optical cores 414. The electronic control system 420 may apply an electric current to each of the optical cores 414 respectively. The temperature of each of the optical cores 414 may be individually regulated by controlling the magnitude of the electric current flowing through each of the optical cores 414.

FIG. 7C schematically shows a cross-sectional view of the light steering component 402 of FIG. 7A, according to another embodiment. Each of the optical waveguides 410 may comprise a conductive cladding 418 around sidewalls of a respective optical core 414. In an embodiment, each of the conductive claddings 418 may be electronically connected to the electronic control system 420. The electronic control system 420 may be configured to individually adjust the dimensions of each of the optical cores 414 by regulating the temperature of each of the optical cores 414. The electronic control system 420 may apply an electric current to each of the conductive cladding 418. The temperature of each of the optical cores 414 may be regulated individually by controlling the magnitude of each of the electric current flowing through each of the respective conductive cladding 418 due to heat transfer between the optical core 414 and the respective conductive cladding 418.

FIG. 7D schematically shows a cross-sectional view of the light steering component 402 of FIG. 7A, according to an embodiment. The light steering component 402 may comprise one or more temperature modulation elements. A temperature modulation element may convert a voltage or current input into a temperature difference that may be used for either heating or cooling. For example, a temperature modulation element may be a Peltier device. The one or more temperature modulation elements may be able to transfer heat to the plurality of optical waveguides 410. In an embodiment, the one or more temperature modulation elements may be in contact with the plurality of optical waveguides 410. In an embodiment, the one or more temperature modulation elements are electronically connected to the electronic control system 420. The electronic control system 420 may be configured to control the temperature of at least one optical core 414 by adjusting the temperature of the one or more temperature modulation elements due to heat transfer between the plurality of optical waveguides 410 and the one or more temperature modulation elements. In one embodiment, the one or more temperature modulation elements may share a common substrate with the plurality of optical waveguides 410. In example of FIG. 7D, the light steering component 402 comprises a layer 422 comprising the one or more temperature modulation elements on a surface of the substrate 430, and the layer 422 is in contact with the plurality of optical waveguides 410.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus, comprising:
a light source configured to generate light pulses, wherein one or more attributes of the light pulses are modulated according to a first code, the one or more attributes of the light pulses selected from a group consisting of amplitudes of the light pulses, time intervals between the light pulses, widths of the light pulses, spectra of the light pulses, and a combination thereof;
a detector configured to receive a mixture of light comprising respective portions of the light pulses scattered by a portion of a target scene, configured to select the portions of the light pulses from the mixture of light based on a second code, and configured to generate electric signals based on a characteristic of the portions of the light pulses.

2. The apparatus of claim 1, wherein the light source is configured to change its total radiant flux as a function of time, based on the first code.

3. The apparatus of claim 1, wherein the light source is configured to change its spectral flux as a function of time, based on the first code.

4. The apparatus of claim 1, wherein the light source is configured to vary a proportion of its total radiant flux in the light pulses as a function of time, based on the first code.

5. The apparatus of claim 4, wherein the light source comprises a shutter and is configured to vary the proportion using the shutter.

6. The apparatus of claim 4, wherein the light source comprises one or more optical filters and is configured to vary the proportion using the one or more optical filters.

7. The apparatus of claim 1, wherein the detector is configured to select the portions of the light pulses by correlating the mixture of light with the second code.

8. The apparatus of claim 1, wherein the characteristic is time-of-flight.

9. The apparatus of claim 1, wherein the light source comprises a light emitter and a light scanner, wherein the light scanner is configured to receive light from the light emitter and affect a direction of the light with respect to the target scene.

10. The apparatus of claim 9, wherein the light scanner comprises optical waveguides and an electronic control system;
wherein the optical waveguides are configured to receive light from the light emitter;
wherein the electronic control system configured to adjust dimensions of the optical waveguides by regulating temperatures of the optical waveguides.

11. The apparatus of claim 10, wherein regulating the temperatures of the optical waveguides comprises applying an electric current through the optical waveguides.

12. The apparatus of claim 11, wherein at least one of the optical waveguides comprises a conductive cladding around a core.

13. The apparatus of claim 12, wherein applying the electric current through the optical waveguides comprises applying the electric current through the conductive cladding.

14. The apparatus of claim 10, wherein the optical waveguides are formed on a surface of a substrate.

15. The apparatus of claim 10, wherein at least one of the optical waveguides is curved.
